(19) United States
(12) Patent Application Publication
(10) Pub. No.: US 2015/0027048 A1
(43) Pub. Date: Jan. 29, 2015

(54) PRODUCE PRODUCTION SYSTEM AND PROCESS

(71) Applicant: GREEN EARTH GREENS COMPANY, Campbell, CA (US)

(72) Inventors: Philip E. FOK, Los Gatos, CA (US); Ken STUTZMAN, Windsor, CO (US)

(21) Appl. No.: 14/447,185

(22) Filed: Jul. 30, 2014

Related U.S. Application Data
(62) Division of application No. 13/174,108, filed on Jun. 30, 2011.
(60) Provisional application No. 61/377,380, filed on Aug. 26, 2010.

(51) Int. Cl. A01G 9/24; A01G 1/00; A01G 7/04

(52) U.S. Cl. CPC A01G 9/24; A01G 7/045; A01G 1/001
USPC 47/66.7

(57) ABSTRACT

A process and system for growing produce decouples farming from the unpredictability of the external environment by moving the farm into a highly-controlled enclosed environment in which all variables are optimized to grow produce of exceptional quality in a consistent, predictable manner, while minimizing or eliminating deleterious environmental impacts. A filtered, positive-pressure environment greatly reduces particulate contamination and pest infiltration from the outside. Seedlings are planted in containers of an organic soil mix engineered to deliver optimal amounts of water, nutrients, fiber and organic matter. The containers advance along a production line, in the process being given controlled exposure to light of predetermined intensity and wavelength, optimized to produce a desired growth pattern. Water is given at regular intervals in amounts calculated to produce optimal growth without waste. Nearly all inputs to the process are fully recyclable or are completely consumed; thus little or no waste is produced.

### CROSS REFERENCE TO RELATED APPLICATIONS

This application is a divisional application of U.S. patent application Ser. No. 13/174,108, filed Jun. 30, 2011, which claims benefit of U.S. Provisional Patent Application Ser. No. 61/377,380, filed Aug. 26, 2010, the entirety of both are incorporated herein by this reference thereto.

### BACKGROUND

1. Field of the Invention

The invention generally relates to growing of produce. More particularly, the invention relates to a produce production process in a controlled environment that optimizes environmental factors to grow produce of exceptional quality and freshness.

2. Background Discussion

Many consumers are becoming increasingly dissatisfied with the emergence of factory farms and conventional methods of raising food crops. First, consumers are concerned with the quality of such conventionally-produced foodstuffs. Modern, large-scale agriculture increasingly relies on the use of copious amounts of chemical fertilizers and pesticides. Consumers are increasingly concerned that the presence of such chemicals in the food supply may constitute a significant health risk. In fact, there is growing evidence that this may be so. Additionally, consumers are concerned that conventionally-produced food may not be as nutritious as, for example, organically-produced food, or food produced by more traditional methods, such as on small, family-owned farms or in backyard gardens. Furthermore, many consumers are concerned about the palatability of such conventionally-produced foods. Often, after harvest, food crops are transported to markets thousands of miles away and may in fact be weeks old before they are consumed. Freshness, flavor and texture often suffer. Also, the use of chemicals is thought to adversely affect palatability. Increasingly, varieties are being grown not because of their wholesome taste and appearance but for their shelf life and their ability to withstand handling. What is more, there is great concern about the proliferation of such varieties that have been genetically modified in an attempt to improve their durability for long-distance shipment.

In addition to quality concerns, there is also great concern about the environmental impact of factory farming. Conventional farming is an open-ended system that requires continuous addition of resources, including water, chemicals, and energy. Agricultural chemicals are largely petroleum-based and extraction, manufacturing and transportation of such chemicals are energy-intensive activities. Factory farming also depends on the use of large-scale, petroleum-powered machinery. Generally, factory-farmed crops are produced at great distances from their markets, so significant energy is required to transport them to market. Agricultural runoff is thought to be a significant source of water pollution. The practice of growing many successive plantings of a single crop in a field is thought to seriously degrade soil quality. Furthermore, the practice of plowing fields that may be several sections in surface area is thought to contribute greatly to soil erosion.

Various methods of growing edible produce in greenhouse environments are known. Hydroponics is one of the most commonly used techniques for greenhouse growing because, being a soilless method, it is simpler and less labor-intensive than other common methods. A hydroponics farmer need only supply the plant the basic nutrients it needs to grow, usually in solution, and need not worry about the other side effects of what's going on in the soil, and so forth. However, only certain varieties grow well in a hydroponic system. Additionally, hydroponically-raised produce has different characteristics than the same variety grown in soil, usually having a soft or somewhat spongy texture.

### SUMMARY

A process and system for growing produce decouples farming from the unpredictability of the external environment by moving the farm into a highly-controlled enclosed environment in which all variables are optimized to grow produce of exceptional quality in a consistent, predictable manner, while minimizing or eliminating deleterious environmental impacts. A filtered, positive-pressure environment greatly reduces particulate contamination and pest infiltration from the outside. Seedlings are planted in containers of an organic soil mix engineered to deliver optimal amounts of water, nutrients, fiber and organic matter. The containers advance along a production line, in the process being given controlled exposure to light of predetermined intensity and wavelength, optimized to produce a desired growth pattern. Water is given at regular intervals in amounts calculated to produce optimal growth without waste. Nearly all inputs to the process are fully recyclable or are completely consumed; thus little or no waste is produced.

### BRIEF DESCRIPTION OF THE DRAWINGS

FIG. 1 shows a multi-tiered growing rack for raising seedlings;

FIG. 2 illustrates a ventilation system for the growing rack of FIG. 1;

FIG. 3 illustrates a seedling that is ready for transplant to a growing tray;

FIG. 4 provides an elevation view of a production lane in a system for growing produce;

FIG. 5 illustrates a lighting system in the production lane of FIG. 4;

FIG. 6 illustrates a LED (light-emitting diode) panel in the lighting system of FIG. 5;

FIG. 7A provides a plan view of a light panel layout from the lighting system of FIG. 5;

FIG. 7B is a matrix showing the number of days of full light exposure over the course of 7 days;

FIG. 8 shows a plan view of the production lane of FIG. 4;

FIG. 9 shows a planting mat in a system for growing produce;

FIG. 10 provides a detailed illustration of the planting mat of FIG. 9;

FIG. 11 shows a second plan view of the production lane of FIG. 4, wherein the planting mat of FIG. 9 is shown deployed;

FIG. 12 illustrates a growing tray from a system for growing produce;

FIG. 13 illustrates a watering system in a system for growing produce

FIG. 14 illustrates a computer display of data gathered via a telemetry system from a system for growing produce; and

FIG. 15 provides a diagram of a machine in the exemplary form of a computer system within which a set of instructions, for causing the machine to perform any one of the methodologies discussed herein below, may be executed.

### DETAILED DESCRIPTION

A process and system for growing produce decouples farming from the unpredictability of the external environment by moving the farm into a highly-controlled enclosed environment in which all variables are optimized to grow produce of exceptional quality in a consistent, predictable manner, while minimizing or eliminating deleterious environmental impacts. A filtered, positive-pressure environment greatly reduces particulate contamination and pest infiltration from the outside. Seedlings are planted in containers of an organic soil mix engineered to deliver optimal amounts of water, nutrients, fiber and organic matter. The containers advance along a production line, in the process being given controlled exposure to light of predetermined intensity and wavelength, optimized to produce a desired growth pattern. Water is given at regular intervals in amounts calculated to produce optimal growth without waste. Nearly all inputs to the process are fully recyclable or are completely consumed; thus little or no waste is produced.

### The Starting Area

The initial stage of the growing process involves the production of seedlings. In general, the production of seedlings may include one or more of the following steps:
Seedling soil preparation;
Seedling tray preparation; and
Seed planting.

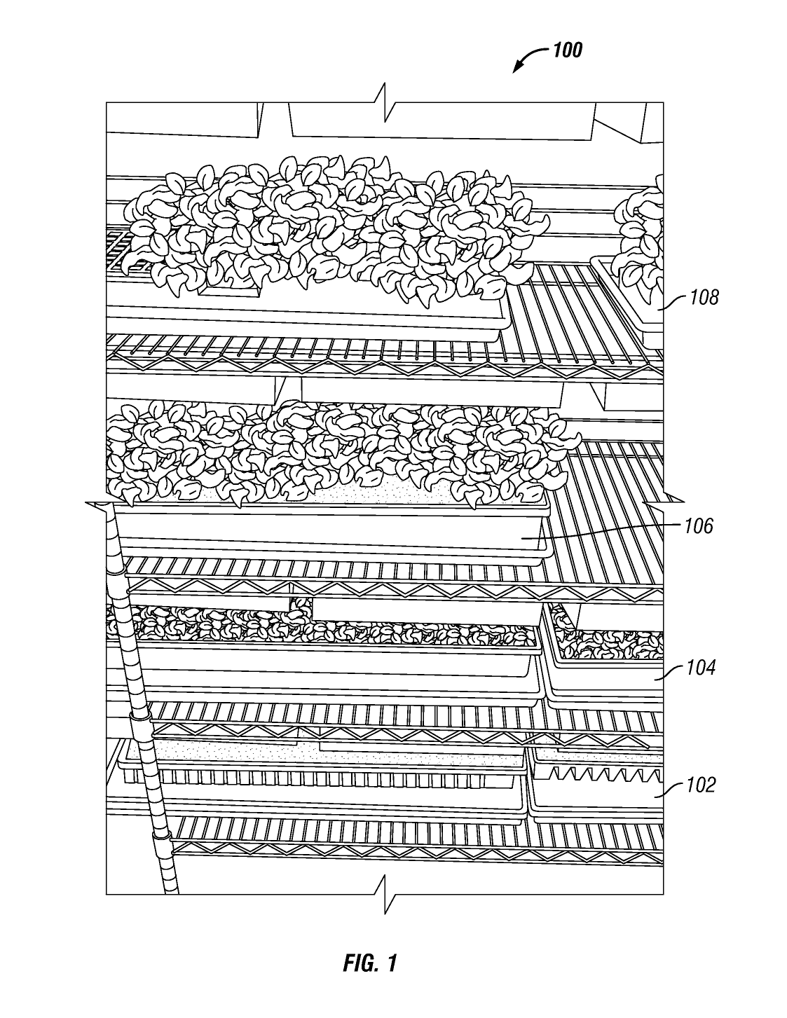

In an embodiment, seedlings are planted and raised in a dedicated environment so that environmental factors can be calibrated to the specific growth requirements of the seedlings, as shown in FIG. 1.

One objective is to maximize utilization of light energy throughout the life of the plant. Therefore, varying degrees of packing density are used depending on the maturity of the plant. Many vegetable varieties happen to thrive in a temperature range comparable to a typical office environment. Other varieties may require different conditions which can be controlled using the same processes. While every effort is made to maintain a stable ambient temperature, thermal energy given off by the lighting system, which system is described in greater detail herein below, may lead to a temperature gradient in the controlled environment. Rather than trying to eliminate this natural temperature gradient, plants may be arranged to take advantage of the conditions at each level. Seedlings that become too warm can grow too quickly, which causes them to become susceptible to disease, die-off and other developmental problems. In order to minimize temperature gradient effects, the seedlings may be positioned at varying distances from light and/or heat sources, depending on their age. FIG. 1 shows a multi-tiered growing rack 100 for raising seedlings. Seedling trays 102-108 may be shelved in a stacked configuration, wherein the youngest seedlings 102 are kept at the bottom, where it is coolest. At the next stage, the seedlings 104 move up a level. Each successive stage moves up a level to gradually warmer conditions until the seedlings are ready for transplant 108. FIG. 3 shows a seedling 300 ready for transplant.

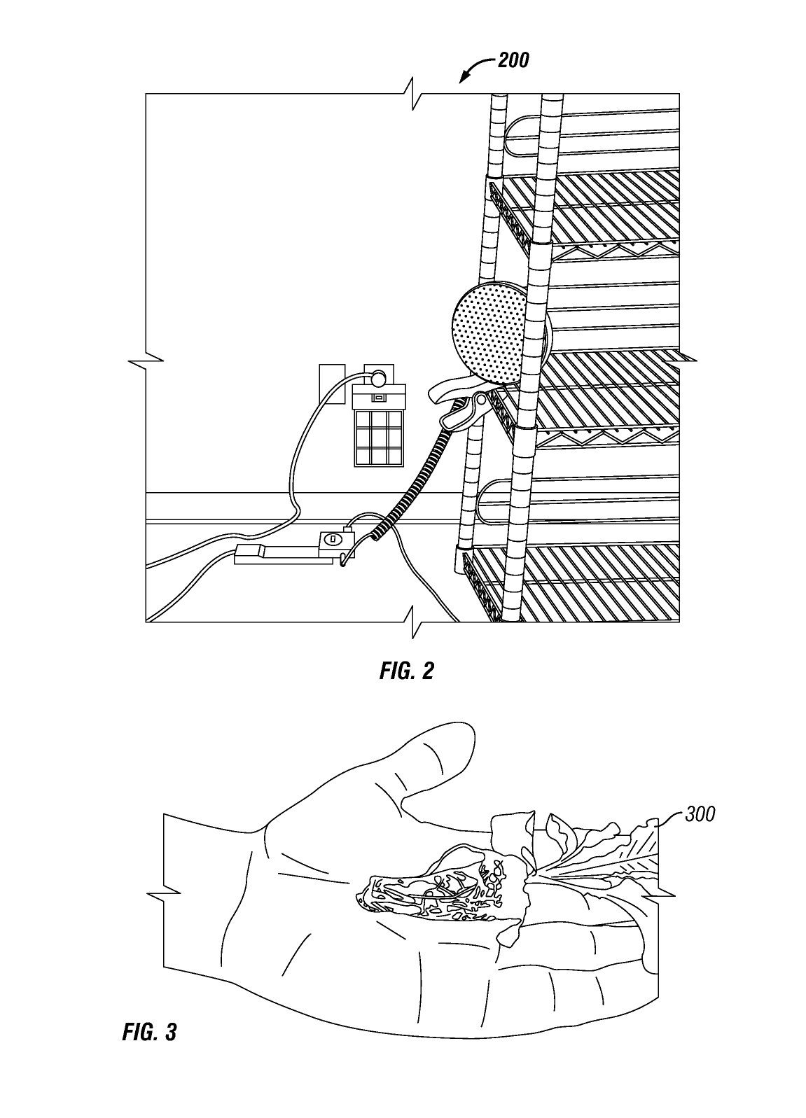

It has also been determined that seedlings thrive when provided an optimal amount of air circulation. In an embodiment, shown in FIG. 2 one or more air circulation devices, such as fans 200 are used to provide a degree of air circulation that does not permit oxygen buildup, which slows plant growth, while not allowing a degree of air circulation that allows the seedlings and the seedling trays to dry out too quickly. The person of ordinary skill will recognize that a variety of approaches and apparatus can be used to deliver the correct amount of air current to the seedlings. More is said about the ventilation system herein below.

CO₂ and humidity are monitored, as well, via sensing devices. Optimal growth requires sufficient availability of CO₂, as well as moderate humidity levels to insure transpiration through the leaf surfaces.

Additionally, experimentation has revealed that seedlings in a controlled environment such as herein described thrive best when light is delivered by the lighting system described herein below in predetermined lighting cycles. In an embodiment, a lighting cycle may be controlled to produce a vigorous growth response from seedlings of leafy greens, such as spinach and lettuce. Seedlings of fruiting plants, such as tomatoes and peppers typically perform best with different lighting cycles, many of which may differ from nominal “daylight hours”. Other crops, for example, rooting crops such as onions, thrive on still different lighting cycles. Since the efficiency of energy delivery from LEDs in photosynthetic peaks can be much higher than comparable sunlight, deleterious effects on plants may be avoided by adjusting the exposure timing.

In an embodiment, one or both of the lighting cycle and the light intensity may be manipulated in order to affect the appearance of the final product. For example, the color intensity in colored varieties of lettuce can be influenced by manipulating any or all of the lighting cycle, the light intensity and the light spectrum ratios.

### Lighting System

In an embodiment, a lighting system 500 is configured from one or more LED lighting panels 600. Using such LED panels enables the producer to grow plants year-round with greatly reduced energy cost. Extreme energy efficiency permits the LED panels to save 50% to 90% in energy consumption compared to conventional growing light sources. This is due to multiple factors, for example: the high light output-to-power ratio of the LEDs, the low heat output of the lights, and the ability to position the lights in close proximity to the plants.

In an embodiment, the lights may have a predetermined configuration designed to produce the best growth. Typically, red light encourages vegetative growth and blue light encourages flowering or fruiting activity. However, quality plant growth usually requires a combination of blues and reds. The ratio of blue to red varies depending on the characteristics desired, and may also vary depending on the stage of growth of a particular variety. In any case, because LEDs are point sources of discrete light, to assure quality growth, all plant surfaces may be exposed to all frequencies of light over the course of their growth cycle.

Depending on the light requirements of the particular crop, the lighting system provides the flexibility of varying the spectrum of light delivered to the plants. Thus, the lighting system is readily configured to provide blue and red light in varying ratios. For example, in an embodiment, a ratio of 23% blue and 77% red may provide consistent, steady growth without producing plants having abnormal shapes or other anomalies.

Additionally, as shown in FIG. 1, the distance between the light source and the plants is readily re-configured. Thus, typically, when seedlings are small and immature, the light source is kept in closer proximity to the plants. As the seedlings mature, the distance between the light sources and the foliage may be incrementally increased. In an embodiment, the distance is continually readjusted in order to maintain a constant distance between the light sources and the foliage. Thus, by carefully adjusting the distance between the light sources and the top surfaces of the plants, it is possible to avoid incurring photo-damage to the plants. Even though the light sources do not heat up significantly, it is possible to give the plants, in effect, sunburn, if the foliage is over-exposed to excessive light intensities.

### Light Distribution

In order to insure uniform growth, all of the plants typically receive an equal amount of light. Spot defects and edge effects may result from uneven light-density distributions. Accordingly, a number of features are designed into the process with the end goal of smoothing out the lighting effect.

In an embodiment, the LED bulbs are point-sources of light and may have a relatively narrow light cone—narrow enough to readily produce spot distortions. In order to prevent distortions, the positioning of the trays is modified slightly at predetermined time intervals. Over the course of their growth, seedling trays are shifted relative to the light source to homogenize the light frequency exposure over the surface of the trays. In an embodiment, when they change levels, the trays are rotated, one hundred and eighty degrees, for example, to insure that light exposure is as uniform as possible for all plants. In this way, spot distortions may be prevented.

In an embodiment, the trays of seedlings are shifted manually at regular intervals, for example, once daily, when the seedlings are watered. In a further embodiment, shifting the trays is automated, by for example, placing the trays on a powered supporting surface or structure that is configured to change position in predetermined patterns at predetermined time intervals.

In a still further embodiment, uniform growth may be assured by equipping the lighting system with LED bulbs having a wider light cone with equivalent energy output per unit area. In a yet further embodiment, the wider light-cone LEDs may be combined with one or both of manual and automated shifting of the seedling trays' positions.

Additionally, a light concentration gradient from the edge of the plant line to the center of the tray may occur, so edge effects, as well as spot defects can be an issue. Reducing or eliminating edge effects tends to reduce or eliminate the problem of having under-sized plants at the edges of a tray because of the reduced light concentration at the edges. In an embodiment, seedling trays and lighting panels are sized relative to each other so that the outer dimension of the lighting panel is larger than the outer dimension of the seedling tray, resulting in the light concentration gradient being reduced or eliminated.

### Watering

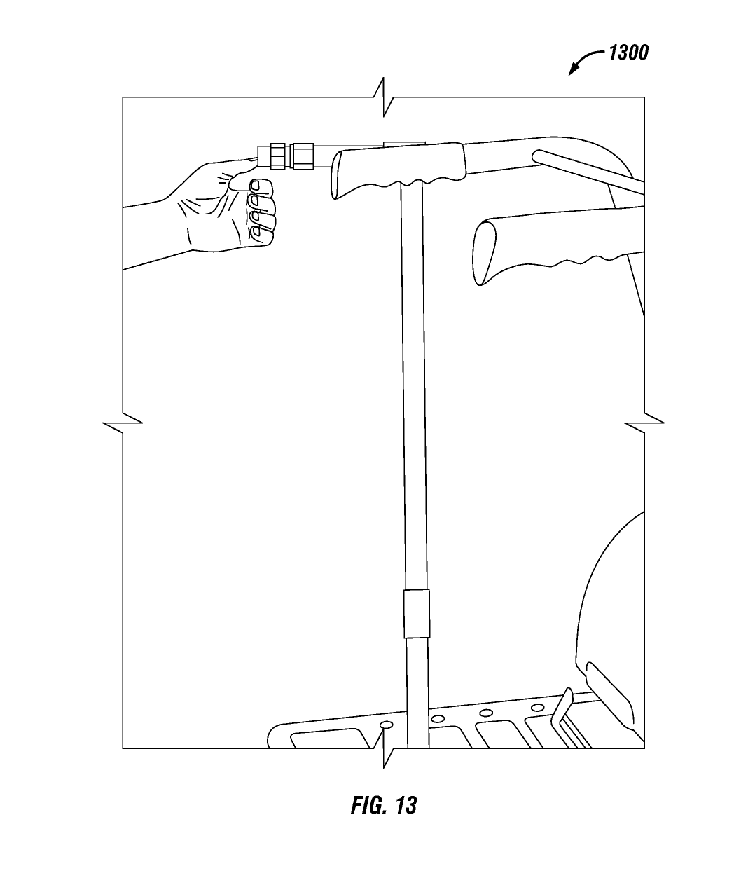

In an embodiment, the seedlings are manually watered at predetermined intervals, for example, once per day using a system 1300 such as shown in FIG. 13. Manual watering may be accomplished with a fluid delivery device such as a tank sprayer or water hose equipped with a device for metering flow, such as a nozzle calibrated to deliver a predetermined amount of water per unit of time. In an embodiment, watering is automated using a sprinkler system or drip irrigation system controlled by an automated timer/meter element configured to deliver water at predetermined intervals and in predetermined amounts. In an embodiment, the total weekly water requirement for 3400 seedlings is approximately 1.5 gallons. Thus, by using the approaches and methodologies herein described, it is possible to achieve great economies in water use, thereby greatly ameliorating any adverse environmental impact while producing food crops of exceptional quality.

In an embodiment, water is sourced from any conventional municipal supply or well. There are areas in which municipally-supplied water is of very poor quality. For example, in certain areas, the salt content of water from the municipal supply is extremely high, which can cause problems for certain types of plants. Accordingly, water quality is carefully monitored for, for example, mineral and salt content and pH. In additional embodiments, bottled water, distilled water, cistern water or even grey water serves as the water source.

The use of high density seedling trays during the early stages of growth maximizes the energy utilization of the LED lights and further enhances the energy savings of the system. Lighting cycles, soil nutrient levels, and environmental factors may all be controlled to insure quality growth of the seedlings in preparation for transplant into the final grow trays.

### Transplanting

### Grow Tray (1200) Soil Preparation

The soil used in this system is more than a medium to support the root structure. The components of the soil are selected to support the microbiological activity to enable sustained growth of successive crops over an extended time period, similar to a plot of farmland. The soil is periodically replenished with nutrients. However, since there is no runoff of excess water, nutrients are retained in the soil over a much longer period of time without the need for supplements.

The nature of the components in this soil mixture makes the initial water loading the primary source for short-term crops such as lettuce. Successive water additions replace moisture consumed by plant growth or lost to evaporation.

As will be explained in greater detail herein below, the growing crops are sparingly watered and the grow trays 1200 do not permit any runoff. Thus, minerals and nutrients are not washed away as in conventional agricultural methods. Accordingly, the soil retains minerals and nutrients and the mechanical quality of the soil is well maintained. In an embodiment, when the seedlings are ready for transplant, they may be transplanted to grow trays. There follows a description of a process for grow tray preparation and assembly:

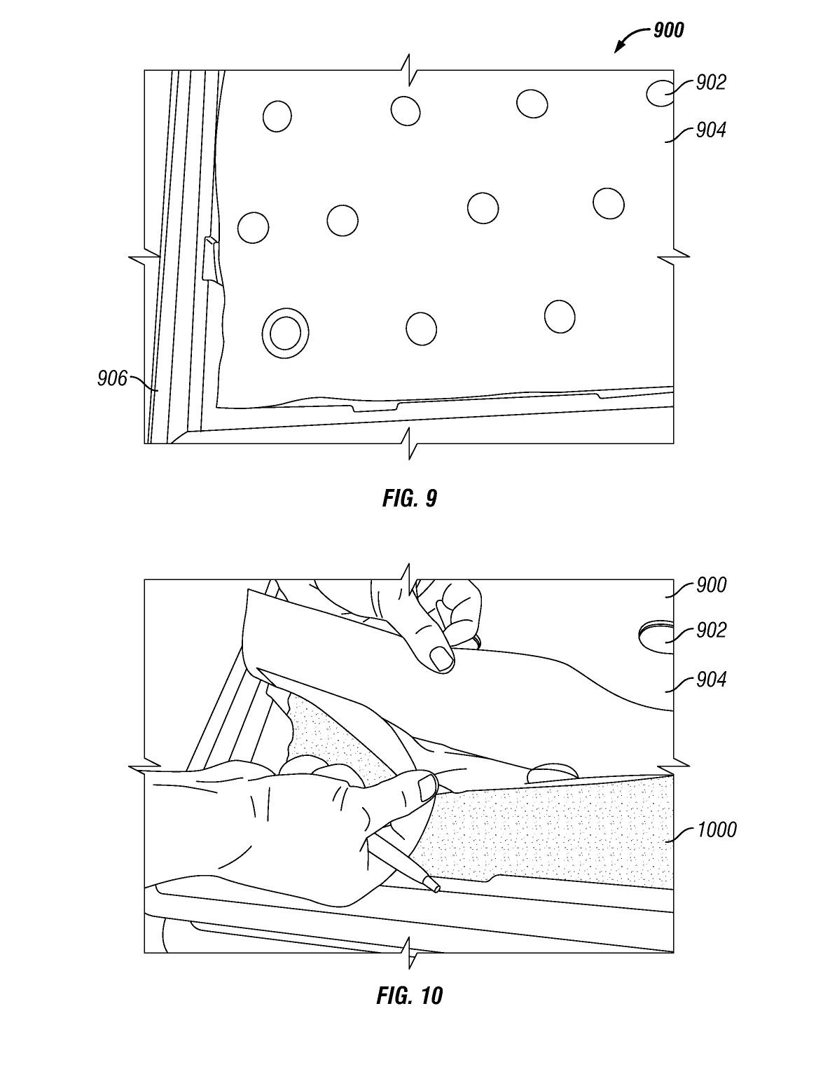

The process of planting the grow tray 1200 may involve a planting mat 900, first shown in FIG. 9, a novel tool that performs a number of important functions. First, the planting mat 900 serves as a templating tool which allows the planting of seedlings into the grow tray in an arrangement that promotes optimal use of space, light, water and nutrients. The planting mat also provides a wicking effect that greatly promotes even distribution of water to the plants, so that every plant receives the water it needs without any water being wasted. Additionally, the planting mat serves to reflect light from the soil surface so that it can be used by the plants for photosynthesis. Additionally, the planting mat facilitates management of the production facility environment by regulating heat absorption by the soil. Below, a process for the preparation of a planting mat is described:

### Planting Mat (900) Preparation

Tools and materials:
Hole punch and die;
Hammer;
Spacing template;
Felt;
Weed block fabric;
Scissors;
Marker; and
Grommets.

### Procedure

Cut a square of both the felt and the weed block fabrics. In an embodiment, the felt may be white and the weed block fabric may be black. In an embodiment, the fabric squares may be cut approximately 36″ on a side;
Sandwich the fabrics together and place the spacing template on top of the fabric sandwich;
Mark locations of holes with the marker;
Place a plastic backing piece behind the hole to be punched;
Using, for example, a ⅜″ hole punch and die and, for example, a small plastic hammer, punch holes through both layers of fabric, keeping the layers oriented and aligned at all times;
Snap a plastic grommet, measuring, for example, 1⅜″ on each corner hole to hold the layers together; and
Optionally, add another grommet to the center hole for additional security.

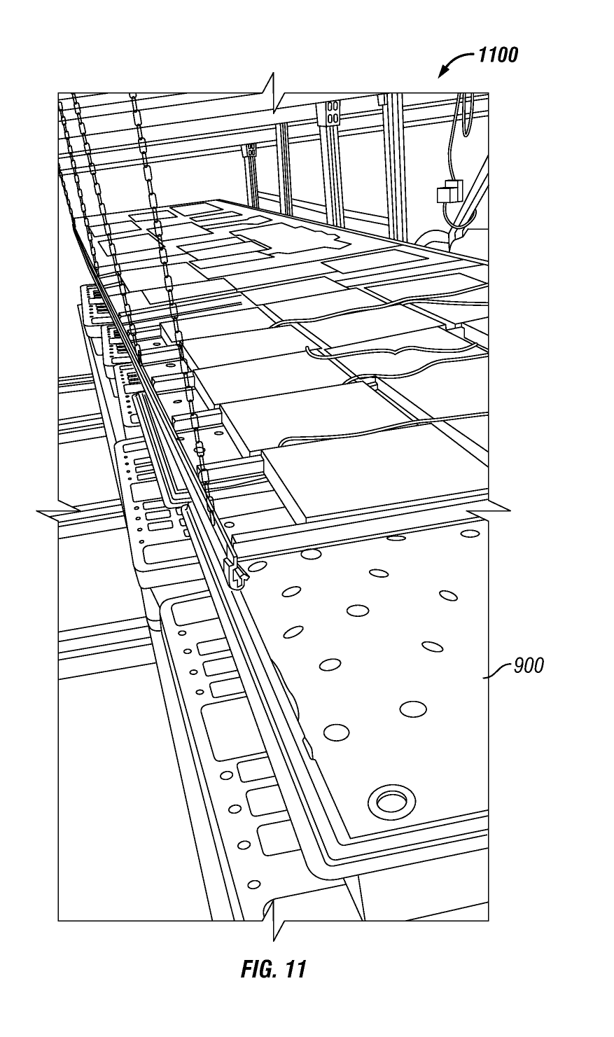

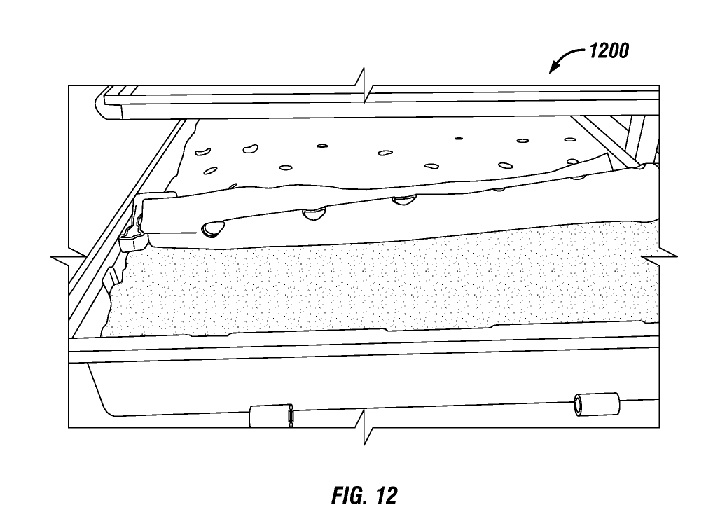

As above, the planting mat may incorporate fabrics of different types. In an embodiment, the first fabric may be a polyester felt fabric 904 of a light color, for example, white. In other embodiments, the felt may be a natural fiber such as cotton or wool. In an embodiment, the second fabric may be a thin, plastic weed-block fabric 1000 of a dark color, for example, black. In an embodiment, the planting mat is placed over the bare soil, as shown in FIGS. 9 and 11, after which plants are inserted into the soil through the holes 902. The planting mat is fabricated by fastening the fabric layers 904, 1000 together with fasteners 906 such as grommets or rivets. In an embodiment, the layers may be sewn together. The felt fabric and the weed-block fabric allow water and air to penetrate, while discouraging evaporation. Thus, the planting mat helps to conserve moisture, further reducing water requirements.

The light color of the felt fabric is photo-reflective, thus maximizing the light efficiency of the lighting elements. It also prevents the soil from absorbing light and then turning that into heat, or blackbody radiation, thus allowing the temperature in the production facility to be controlled much more uniformly. The dark-colored weed-block fabric has another effect. Without the dark layer, the light penetrates the white fabric, which allows growth of such undesirable life forms as algae and molds on the surface of the soil, detracting from the nutrient supply to the plants. Thus, the black fabric stops such light penetration and eliminates growth of undesirable organisms.

Additionally, placing the planting mat on top of the soil provides a wicking effect, spreading water across the surface of the soil and allowing it to uniformly and slowly sink into the soil, further reducing the plants' water requirement.

Because the planting mat wicks water so effectively, one can place the watering source in a single place and the water readily spreads evenly over the soil surface.

The planting mat also serves to control the planting pattern. Much like the packing density of silicon wafers in, for example photovoltaic cells, the planting mat serves as a template for, for example, a hexagonal close pack density—the maximum density that maintains a uniform spacing between the plants. One embodiment provides six-inch spacing that allows forty-eight plants to be planted to a single grow tray. Four-inch spacing allows ninety-nine plants in a single tray. Thus, the planting mat serves as an important procedural tool to facilitate scaling of the process in a repeatable, reliable fashion, greatly minimizing the possibility for error in terms of planting density.

### Grow Tray 1200 Planting

Tools and Materials:
Grow tray;
Grow tray soil;
Leveling bar;
Planting mat;
Small seedling spade tool;
Seedlings;
Identification tag;
Marker;
Water hose with, for example, a calibrated flow nozzle attached;
Timer; and
Grow tray production schedule.

Procedure:
Fill tray with prepared moist soil. Press soil evenly over the entire surface;
Use the leveling bar to smooth the top of the soil;
Position the planting mat on the surface of the soil;
use the seedling spade tool and make small holes, for example 1½ inches deep or less, in the soil at each of the planting mat positions;
Pull seedlings from the seedling tray and place in grow tray holes. For seedlings having delicate roots, use the seedling spade tool to help pull the seedling plugs;
Record the variety and original seedling start data, for example on one side of an identification tag. Additionally, record the transplant date, for example, on the other side of the identification tag;
Attach the tag having the information recorded thereon to the tray, for example, near the tray number;
Add water to the tray with the calibrated flow hose. Circle each plant and insure that each seedling plug is well watered. Typically, addition of one gallon of water is accomplished in no more than two minutes. Do not over-water;
Enter the tray information into a production schedule record, for example a spreadsheet. In an embodiment, the spreadsheet includes one or more scripts or programs that calculate a weekly watering schedule;
In an embodiment, grow trays may be placed on the uphill side of the grow rack.

### Watering Grow Trays

Tools and Materials:
Calibrated moisture meter;
Watering hose with calibrated flow nozzle;
Timer; and
Production schedule record.

Procedure:
Water using the hose, circling each plant with the nozzle, near the surface, if possible. If plants are too large to allow the mat surface to be seen, then spray the surface of the plants gently;
Spot check in at least 3 positions with moisture meter to insure that the soil is sufficiently watered;
Update the production schedule, for example, by shading in the completed tray watering date to indicate completion.

While a uniform spray is generally used to water the grow trays 1200, the planting mat 900 helps to spread the water more uniformly, as mentioned above. It also drains very quickly so it retains very little water and dries very quickly—within minutes. By watering the grow trays using the foregoing method, the soil is kept damp enough for the plants to thrive, but not so wet that nutrients are washed away. FIG. 11 shows a plan view 1100 of a production lane, wherein the planting mat 900 is shown deployed.

### Growing

Typically, the planted grow trays remain in the production facility until harvest. In an embodiment, the production facility is configured as a lane 400 along which the grow trays are moved, much like a production line in a manufacturing facility. One element of the lane is a growing rack 402 upon which the grow trays rest in between watering. In an embodiment, the growing rack 402 may be a gravity-feed pallet rack, similar to those used in warehouses.

One of the principles employed in configuring the production facility is the imperative of keeping water and power separate in order to provide a high measure of safety. Because growing plants require regular watering, a large production facility typically requires at least one, and possibly many more, extensive watering systems. It is recognized that, in spite of active preventive maintenance, leaks in a large-scale watering system are near-inevitable. If the watering systems are deployed in close proximity to electrical systems, the likelihood of a fire or other disaster resulting from a shorted electrical system caused by leaking from the water system is considerably increased. Thus, in an embodiment, watering systems and electrical systems are segregated as much as possible. Additionally, by providing a highly-absorptive planting soil, the cycle time between watering is extended, for example, up to one week, which also limits the possibility that water and electricity will come into contact with each other.

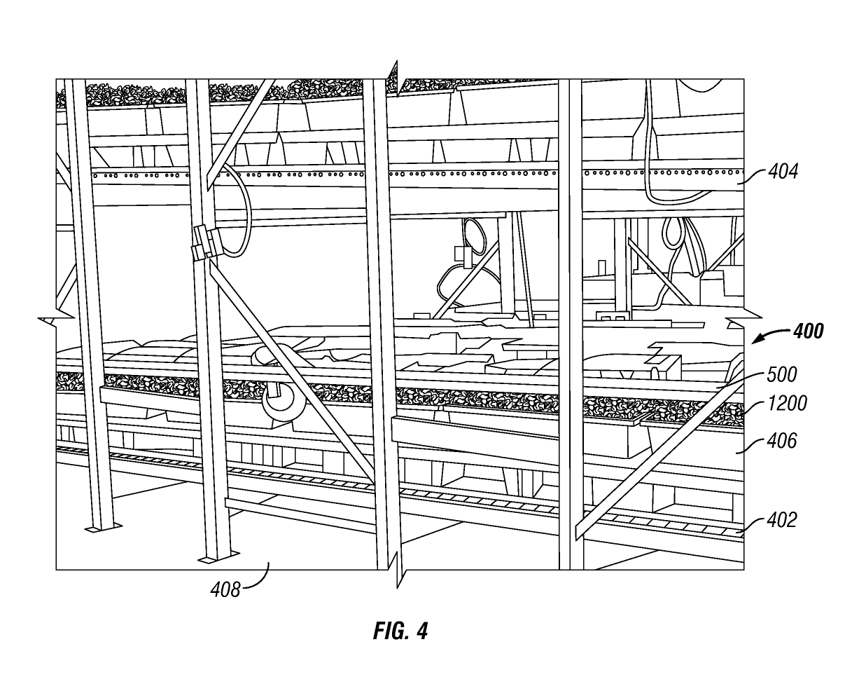

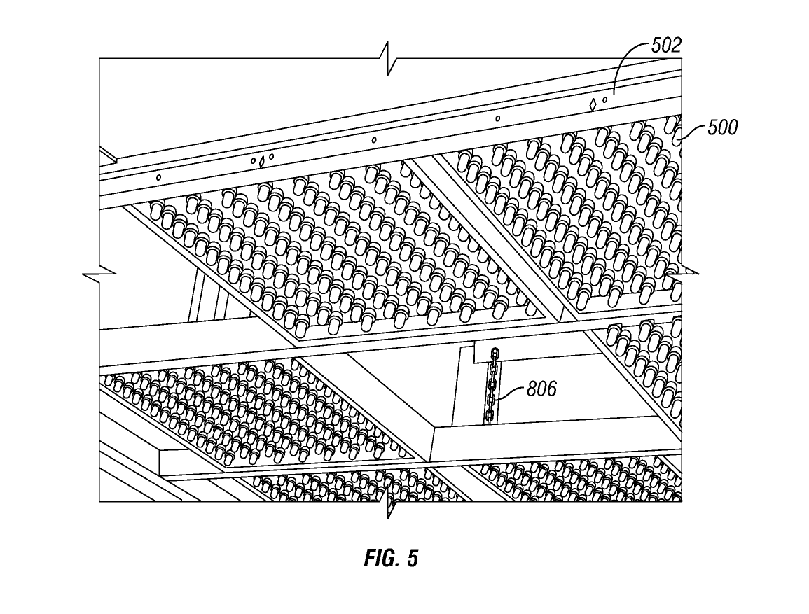

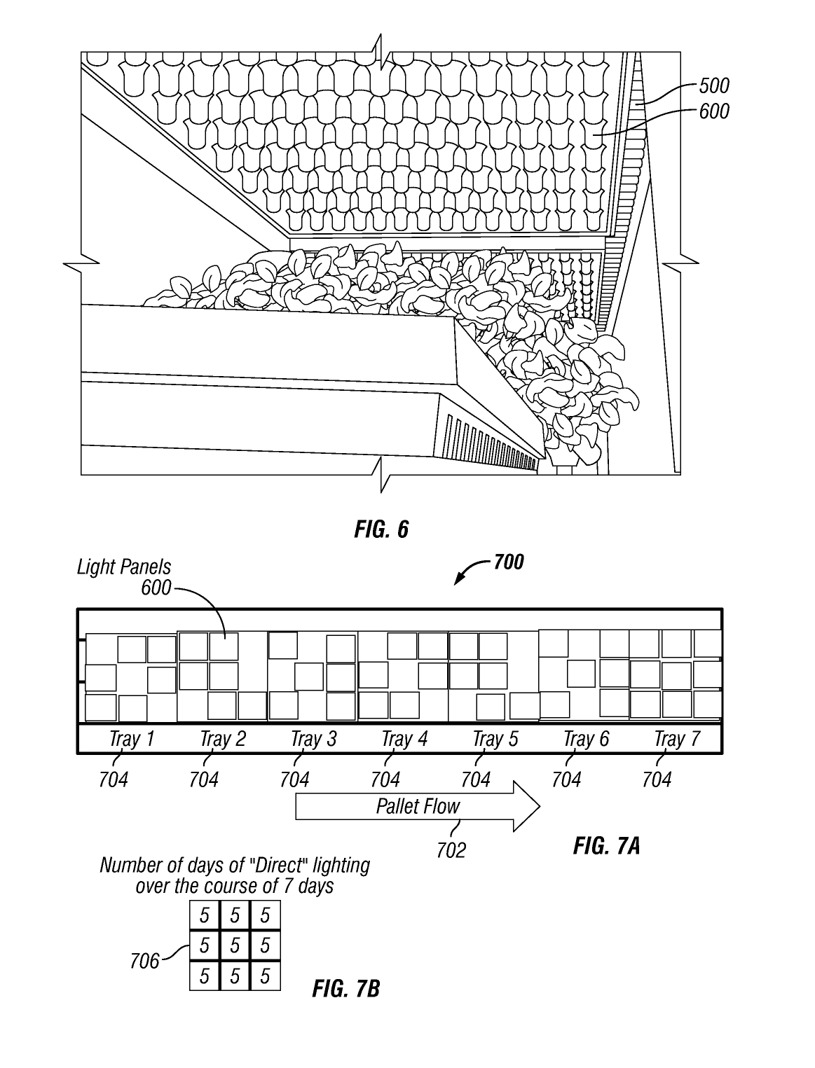

In an embodiment, as shown in FIG. 4 a growing rack 402 is configured to provide a slight incline 408 in the forward direction of the lane.

In an embodiment, one arrangement accommodates seven pallets 406, each containing a grow tray 1200 When a grow tray is started, it is watered and placed into the far end of the high side of the growing rack. Each day, the tray at the opposite end is removed from the rack, watered and then cycled back to the far end, with each tray indexing down, assisted by the gravity-feed mechanism of the grow rack. In this way, watering one tray each day, within a week, each tray is watered once. While it is recognized that the seven-tray arrangement is particularly conducive to the management of growing schedules and inventories, there exist additional embodiments that are also conducive to management of the production process. For example, in one embodiment, the lane is of a length such that a fresh tray is placed in at the starting end and by the time it makes its way through the entire lane, it is ready for harvest.

In another embodiment, parallel lanes 400 are joined by ball tables, which provide the ability for the trays to make a u-turn. Thus, a tray comes out, is watered, and turned around on the ball table to start its descent down the next lane.

In yet another embodiment, the lane is twenty-eight pallets long and has a watering station every seven places, for example. It is recognized that the configuration of the lane is mostly a function of production requirements and the design of the enclosure housing the process.

Because the lane is on a slope, each of the pallets has both high and low sides. In an embodiment, during watering, when the tray is pulled out and put back into the rack after watering, the pallet is maneuvered in order to alternate the high side and the low side. In an embodiment, rotating the high and low sides is automated, for example, by means of ball table or a turn table, as previously described. Thus, over a period of time, measures are taken to keep growing conditions very uniform. Additionally, in certain embodiments, a certain amount of variation in conditions is deliberately introduced in the process to simulate, for example, the randomness found in completely natural growing conditions. For example, high side or low sides are not rotated.

The foregoing embodiments each accomplish the desired movement through the lane, while allowing uniform lighting over the entire surface, and automatically maintaining a regular watering schedule. Because the gravity-feed system requires no power, production is not limited by unforeseeable occurrences such as power failures or brown-outs. Furthermore, the use of water in the vicinity of electrical components is not required, thereby greatly decreasing the possibility of an electrical fire. Additionally, a completely mechanical system that is driven only by gravity provides still another opportunity for conserving resources in general and energy in particular. In an embodiment, a production facility may contain a plurality of production lanes 400. Additionally, as shown in FIG. 4, a single lane 400 may include multiple levels 404, so that each lane, in actuality, comprises multiple lanes.

For the purposes of monitoring the condition of the crops during the growing period, every lane is accessible from at least one side to provide a means for visual inspection.

### Lighting

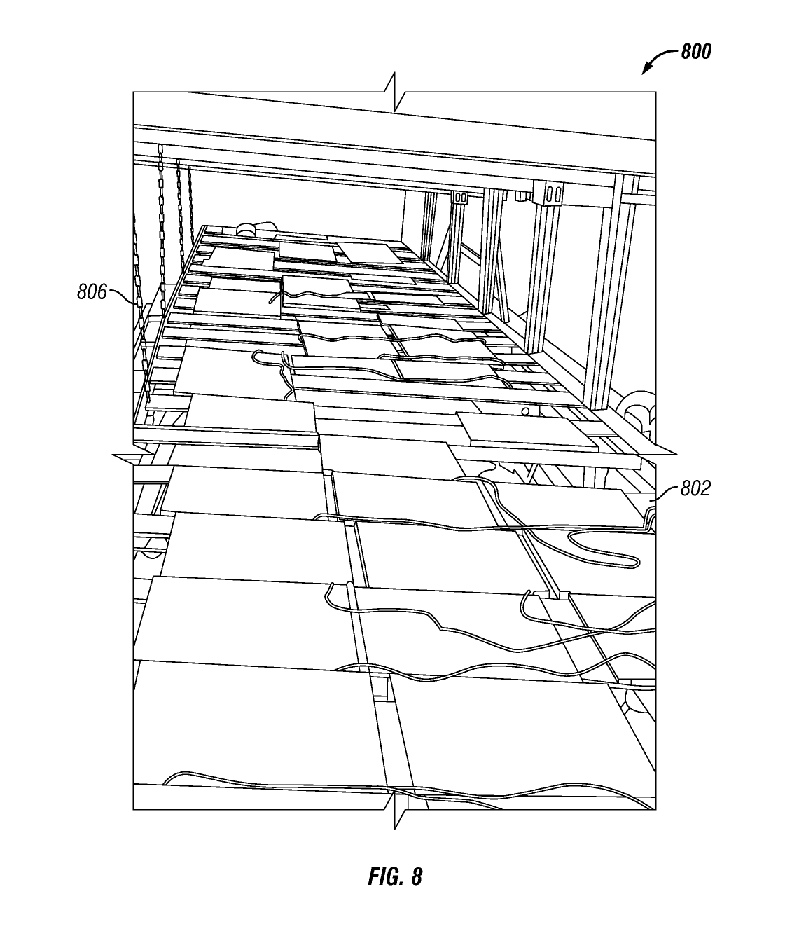

A certain amount has already been said about the lighting system 500. Another feature of the lane is a system 500 of lighting components that provide controlled exposure to light as the pallets containing the trays are advanced through the lane. In an embodiment, the lighting system may be composed of, for example, LED lighting panels 600 that are suspended at one or more predetermined heights above the lane, so that light energy is delivered to the plants as the grow tray within which they are contained passes beneath the lighting panels. In an embodiment, the means for suspending the LED panels may constitute a grid 502 similar to that used to suspend a drop ceiling. In an embodiment, the external shape of the grid may be defined by a frame constructed from lengths of perimeter molding or perimeter bracket fixedly or removeably attached to each other to form a grid in the desired shape and size. The grid pattern is established by securing a plurality of runners within the frame parallel to each other at pre-determined distances from each other. Subsequently, cross tees are fastened, perpendicular to and between the runners to complete the grid. After the grid is suspended over the lane, the LED panels are received by the cells of the grid. In an embodiment, a system of clamps and conduit may conduct wiring 802 necessary to supply power to the LED panels 600. FIG. 8 shows a second plan view 800 of the production lane 400 wherein the grid 502 is suspended by means of suspension elements such as chains 806. It will be readily appreciated that other suspension elements such as cables are equally suitable.

It will be appreciated that the foregoing lighting system 500 is highly configurable. In an embodiment, for example, LEDs 600 may be distributed across the panel in different densities—single density and double density, for example. In an embodiment, a single-density, or 1× density panel, may contain approximately one hundred and twelve LEDs. A double-density, or 2× density panel, may contain approximately two hundred and ten LEDs. The number of LEDs in a panel is, of course, easily varied, according to the needs of the particular crop, the enclosure configuration, the availability of uniform natural light and a host of other environmental factors. With the differing light densities, it is a relatively easy task to accommodate the differing light requirements of different plant species, or the differing light requirements of a single plant species at different stages of the plant life cycle. For example, in the earliest stages, approximately two weeks, the lower-density lighting provides sufficient light for the plant, partly because the plant requires less light and also because a larger area of the planting mat is exposed, thus reflecting more of the incident light. Thus, a lower-density light, used at the proper stage of the plant's life, allows use of less light, and therefore less energy but, still, with good effect.

Additionally, it has been determined, that, in many cases, not only does supplying more light not provide an advantage, it may actually result in poor growth, even very poor growth. Providing the plants with too much light adversely affects plant growth because the increased light level alters certain chemical processes within the plant, causing them to go into a protective mode, and growing much slower. Additionally, subjecting the plants to too light much can result, for example, in tip burn, even though the light from the LED panels 600 is not particularly hot. Thus, not only is energy wasted, but output suffers.

In addition to manipulating light density, as has already been alluded to, it is also possible to manipulate the lighting cycle to affect the plant growth cycle. Certain plants respond to varying light cycles. For example, some types of onions require lengthening days (such as experienced during Spring months) to trigger bulb formation. Other effects such as increased leaf counts can be triggered by differing light cycles.

As has already been suggested, growth may be affected by varying the distance between the light source and the tops of the plants.

In a further embodiment, the distribution of the LED panels 500 within the grid 502 may be modified in order to mimic the uneven lighting encountered in the natural environment caused, for example, by variation in cloud cover. In some embodiments, sequences of LED panels may be removed from the grid in a specific order, as shown in FIG. 7A, in order to mimic the effect, found in nature, of a cloudy day, when plants in the outdoors receive, for example, indirect light as a result of heavier cloud cover for that day.

FIG. 7A provides a first plan view 700 of the lighting system 500, illustrating a light panel distribution that permits the system to simulate the uneven lighting of the natural environment. Pallet flow 702 along the production lane 400 is shown, wherein a single growing tray 1200 occupies each position 704 along the production lane 400. As elsewhere described, each tray 1200 occupies a pallet, which advances the tray 1200 along the production lane 400 as the tray at the front of the queue—here Tray 7—is watered and then removed from the front position at the production lane 400 and replaced at the rear position, here occupied by Tray 1.

As shown in FIG. 7A, a full-coverage light panel pattern requires, for example, 9 panels, as shown for the Tray 7 position. Sixty-three panels (7×9) permit full coverage along the entire production lane 400. However, in each of the remaining positions, panels are removed in order to vary the lighting panel distribution at each position along the lane 400. While the panel distribution at each position varies from each of the other positions, the number of panels removed is kept constant. In the illustrative embodiment, 3 panels are removed. The number of panels removed is readily varied, however. For example, in an embodiment, 4 panels may be removed, leaving 5 panels to provide illumination.

It will be appreciated that, because the number of panels removed remains constant, over the course of a week, the entire surface of a growing tray 1200 receives uniform lighting, but, in effect, every plant in the grow tray sees a day or two of “cloudy” weather, interspersed with days of bright, relatively unfiltered light. For example, in the illustrative embodiment, each tray, over the course of a seven-day watering cycle receives a total of five days of full light exposure. As shown in the matrix 706 in FIG. 7B, each unit of surface area within a tray 1200 illuminated by a single panel 1200, over the course of the 7-day watering cycle, receives 5 days of full light exposure, even though the light distribution varies from day to day. In an embodiment wherein 4 panels are removed over each position 702, each unit of area would receive approximately 4 days of full coverage. In an embodiment, a single unit of surface area in a growing tray 1200 is one square foot. Nonetheless, it will be appreciated that the surface area of a growing tray 1200 may be any size that is consistent with the system specifications and that facilitates achievement of the system operator's business and production goals.

It is again emphasized that the foregoing lighting system is highly configurable. Thus, embodiments allow for even greater variability in the light distribution. For example, in addition to varying the distribution of the panels illuminating a growing tray, an embodiment allows are varying the number of panels from day to day. Additionally, it is possible to provide one or more intervals of relative darkness by completely removing the panels over one or more positions 702.

Experimentation has shown that varying the light in so many different ways results in very uniform growth and very consistent quality. Thus, again, pacing the light by carefully metering it out in this manner helps to insure a consistent, uniform quality over a wide variety of plants. Additionally, it provides another avenue to saving significant amounts of power—in this case, 28 percent less than a full-coverage pattern.

While meeting the plants' energy needs with electrically-powered lighting systems consumes relatively more electricity than conventional agricultural methods that directly rely on the sun to meet the plants' energy requirements, in terms of net energy use, the present methods are at least as energy-efficient as conventional agricultural methods. The present methods enjoy the significant advantages of not requiring petroleum-powered farming equipment, such as diesel tractors, combines or trucks. Additionally, conventionally-produced food products are increasingly grown in established areas and are often transported to markets thousands of miles away. For example, in the United States, the vast majority of lettuce is produced in California or Arizona, and then shipped to markets across the country. Thus, lettuce that is purchased in Boston may have traveled twenty-five hundred miles from its source.

In stark contrast, the present methods make it possible to de-couple the production of exceptional-quality food crops from the uncertainties, such as drought and other inclement weather, poor soil conditions and pests, endemic to conventional agriculture, enjoying great flexibility in the location of growing sites. Sites can be located in deserts as well as in densely-populated urban areas. Thus, in the foregoing example, the Boston area can be supplied with lettuce produced in a facility sited in downtown Boston, where it can be grown, harvested and quickly shipped to local markets, even on the day of harvest.

Thus, if the dollar expense and energy expenditure of transporting the conventionally-raised lettuce twenty-five hundred miles and refrigerating it over that distance is factored into the cost equation, the cost advantage and energy-savings provided by the present approach become very clear. The locally-produced crops are fresher, available year-round, the cost of production is less and net energy use is significantly less than that involved in shipping produce halfway around the world or across the country.

Additionally, the economics of the present method offer a granularity that is impossible in conventional monoculture-based agriculture, because it is unnecessary to dedicate a large expanse of land to the growing of a single crop. Thus, it is entirely possible to grow only one or two trays of a particular crop, allowing for great variety and flexibility. In fact, in an embodiment, split trays are produced, wherein different varieties are planted in the same grow tray. In an embodiment, a split tray is configured on order. Thus, one customer may order one selection and another customer may order an entirely different selection. Thus, for example, if a chef likes a particular spring mix, a grow tray may be built to order containing all of the greens included in the chef's preferred spring mix.

### Climate Control

In terms of climate control, somewhat like greenhouses, the present systems provide a climate-controlled environment for growing produce. Unlike greenhouses, however, the present systems achieve such climate control with far lower energy expenditure than can be achieved by a conventional greenhouse. The location of a typical greenhouse is determined by the available sun exposure. Greenhouses are substantially transparent structures designed to let the sunlight in and are typically minimally insulated. Because of this lack of insulation, green houses have a very high environmental control cost. If the weather is cold, the facility has to be heated. In warm weather, when there is too much sun, the facility has to be cooled. Thus, the energy cost to achieve such climate control is far greater than in one of the presently described facilities.

In an embodiment, a production facility is located within a fully-insulated enclosure, much like a conventional office building. In an embodiment, the enclosure is equipped with a HVAC (heating, ventilation and air conditioning) system that maintains an ambient temperature inside the enclosure approximately equal to room temperature. Thus, the climate-control costs are similar to what an office environment requires. Because very little excess heat is generated by the growing system, environmental control is no more challenging or expensive than in an office building. Fortunately, while some plants tolerate more extreme temperatures than humans, most plants tend to thrive at normal room temperature. Additionally, unlike greenhouses, wherein the humidity is typically very high, the humidity in the present facilities is also like that of an office environment or a light-manufacturing facility such as a semiconductor fabrication facility.

Because the plant density is so high, the present methods tend to generate a large quantity of oxygen (O₂), a by-product of plant photosynthesis. In fact, CO₂ concentration dropping too low as a result of a high O₂ concentration typically slows down plant growth. For this reason, grow facilities are provided with pressurized air sources, such as fans, distributed within the grow racks, in order to generate just enough of an air current to keep CO₂ levels at a steady state. By distributing the pressurized air sources about the racks, each grow tray is assured of being in close proximity to an air supply for single-day periods at intervals of, for example, two or three days. Maintaining steady CO₂ levels encourages very uniform growth without using a lot of power, providing still another opportunity to reduce energy usage while maintaining quality.

As previously described, a natural convection effect results in a floor-to-ceiling temperature gradient, wherein temperature closer to the ceiling is higher than at floor level. An embodiment takes advantage of the temperature gradient by stacking grow trays in racks so that plants that prefer slightly warmer temperatures, like tomatoes and peppers, can be grown on the top level, for example. Plants that thrive at cooler temperatures, such as the lettuces and greens, can be kept at lower levels.

In an embodiment, an air conditioning system auxiliary to the general air-conditioning system is used to deliver cooled or conditioned air deep into the grow trays.

While it is possible to take advantage of the temperature gradient that results from natural convection effects, it is also desirable to minimize such temperature gradients. Thus, an embodiment is equipped with ceiling fans to distribute heat more evenly from floor to ceiling.

### Carbon Trapping

It will be readily recognized that the methods herein described trap large quantities of CO₂. Thus, grow facilities as described herein constitute highly effective carbon sinks. In an embodiment, the grow facilities may serve as carbon sinks to carbon-producing entities such as heavy manufacturing concerns and utilities generating power from coal. Conduits may be provided to deliver CO₂-rich waste from carbon producers to a production facility where it is effectively sequestered in the very plants as a result of plant photosynthesis. Additionally, by being such effective carbon sinks, growers using the production facility may qualify for extremely favorable treatment under current and future cap-and-trade schemes.

### Waste Disposal/Recycling

In addition to sequestering large quantities of carbon, the present methods are highly environmentally-friendly in that the amount of waste emitted from a production facility is virtually zero. After harvest, the plants are the only thing that leaves a facility. As described herein below, roots are removed from the harvested plants and recycled into the soil to retain those nutrients contained in the roots. The roots just compost back, break down, and go back into the soil. Thus, nothing leaves other than the final product.

In an embodiment, the growing soil may be replaced at predetermined intervals and may enjoy further use as a soil amendment in gardens, much like mushroom soil, which is commonly sold as a soil amendment. In another embodiment, the growing soil is replaced only when signs of soil breakdown are perceivable. Such perceivable signs may include nutritional and/or mechanical breakdown.

### Soil Recycling

Tools and Materials:
Harvested planting tray;
Pallet;
Soil mixer;
soil mix;
supplemental nutrients;
Large material scoop;
one gallon bucket;
Shovel;
Water spray timer system;
Planting mat.

Procedure:
Soil is best handled one half of a tray at a time. Shovel half of the soil from the tray into the mixer;
Position the water spray system in front of the mixer. Start the mixer. Set the time to a predetermined interval and allow the water to completely moisten the soil. In an embodiment, the predetermined interval is seven minutes.
Stop the mixer and add the remaining half of the soil from the tray into the mixer.
Add sufficient soil mix to make up any reduction in soil level;
Add supplemental nutrients if soil testing indicates need;
Repeat the watering as specified above;
Dump soil mix into the tray and smooth the surface;
Place the planting mat on the surface of the soil; and
Tray is again ready for planting.

### Business Model

Unlike in the conventional, large-scale monoculture method, using the presently-described methods, it is possible to grow a very fine-grained selection of crops from a single facility. Because of the ability to optimize conditions and to de-couple the growing environment from the external environment, it is possible to grow almost any crop in any facility, no matter what the crop's environmental requirements are and no matter where the facility is located.

In fact, such a fine-grained selection can be produced that it is possible to custom-grow a particular selection of vegetables and fruits to order for a single customer. For example, the customer may be a restaurant and the chef may maintain a highly individual inventory of greens, herbs, vegetables and fruit. In an embodiment, the customer is able to order exactly the selection of produce desired. Ordering can take place by telephone, for example or via an e-commerce web site. Everything ordered by a single customer can be planted to one or more trays just for that customer. In an embodiment, a customer can even visually monitor the progress of his/her crop via, for example, a webcam.

In an embodiment, the ability to customize goes beyond just selecting a mix of varieties and species. As previously mentioned, the methods herein described also allow specification of crops according to a variety of physical attributes: for example, the size of each individual piece. Thus, the customer can specify small, single serving-size heads of lettuce, or bulk size heads. Additionally, as above, the color characteristics of the crop can be specified. For example, the customer may order lettuce of a deep red color, or just having a red-tipped fringe, or that may be a light, lime green. There exists almost an unlimited number of ways in which a crop can be specified or customized.

In an embodiment, such customization can be achieved by systematically varying growing conditions, for example, either the light cycle or the light intensity, or both. It depends on the variety, wherein different varieties each react differently. One particular variety is either a red-tipped, a red-fringed color, or, if exposed to longer light cycles, it will turn red all the way to the core. In this way, it is possible to control just how intense the leaf color is.

An additional benefit of growing produce as described herein is that the final product is extremely clean, which greatly minimizes the amount of time and labor required to prepare it for the plate. For example, a single-serving size head of lettuce may be plated with very little cleaning or other preparation—no more than some trimming and addition of a few garnishes.

Hydroponics is a commonly used technique for greenhouse growing because of its simplicity and ease of implementation. The grower feeds the basic nutrients that the plants need to grow, and does not need to be concerned about soil conditions. Hydroponics has been touted as a solution for raising food crops under inhospitable environmental conditions such as space stations or hostile climatic and/or soil conditions. Unfortunately, not all varieties of vegetables are suited to hydroponic culture. For many varieties, hydroponic farming develops very different characteristics, resulting in produce that tends to be softer with a blander flavor.

By contrast, the approaches herein described also permit fine control over such characteristics of the produce as taste and texture across a wide selection of varieties and species, providing the flexibility to grow virtually anything that grows in soil with good results. Unlike hydroponically-produced or hothouse vegetables, the vegetables that come out of this technique are very palatable, with tastes and textures similar to vegetables grown under ideal seasonal conditions. Taking the minerals up through the soil by the plant tends to result in a much better flavor, being indistinguishable, or nearly so, from produce taken out of the ground. The result is a very crisp texture to the plant, if that is what it was intended to have, and a full range of flavors. The limited amount of water used also has the effect of intensifying the natural flavors. For example, greens such as frisee′, which are characterized by a bitter flavor, develop an intense, concentrated flavor, with a peppery after-taste. Additionally, the present approach tends to produce very aromatic plants. Italian basil, which requires a great deal of heat in order to develop a full flavor and aroma, thrives in the environment provided by the present approach, resulting in plants with great flavor and aroma and catalog-perfect appearance, without needing the heat it is conventionally thought to need. Peppers and the tomatoes also produce well without extreme heat. Thus, plants do not behave quite the same as they do under outdoor sunlight conditions, producing great results, but the knowledge of how to grow a crop under conventional conditions in the outdoor environment does not transfer to growing a crop in the present conditions.

At harvest, because there is little heat, the produce does not need to be subjected to a cooling process nearly to the degree that conventionally-raised produce must be. Conventionally-produced crops, which are grown in large outdoor fields and raised and harvested at high ambient temperatures, often need to be rapidly cooled in order to preserve their quality. In the case of crops, such as lettuce, they are packed in water-resistant containers, such as waxed cardboard boxes. The water-resistant containers are then run through a water chiller to rapidly cool the produce and preserve its quality. The cooling process requires significant amounts of water and inputs of energy. In addition, because of the wax on their surfaces, the cardboard boxes cannot be recycled or composted, so they end up as landfill material.

In stark contrast, produce grown with the presently-described methods, because it has not been grown in high-heat conditions, does not require special cooling in order to preserve its quality. The elimination of a cooling step permits the use of, for example, recycled packaging that is much more environmentally-friendly. Additionally, the elimination of the cooling step spares the additional inputs of water and energy required by conventional processes. Furthermore, the elimination of a cooling step allows produce to be grown more economically, resulting in lower prices for vendors, and, ultimately, consumers.

In an embodiment, produce may also be shipped to customers in multi-cycle cartons fabricated from a material such as plastic. Thus, the customer may keep the empty container and return it when he/she is done with it, allowing the container to be cycled back through and reused many times over.

### Predators and Pests

Because produce is raised in a closed environment such as a warehouse or office building, control of predators and pests is greatly simplified.

In an embodiment, a production facility includes some or all of the features of a clean room environment which is designed to minimize or eliminate particulate contamination from the external environment. In an embodiment, a production facility maintains a positive air pressure, thereby discouraging infiltration by flying insects. Additionally, an embodiment is provided having filters on all of the air intakes to make sure that insects are not introduced via that route. Other embodiments incorporate additional features of clean room environments such as airlocks and gray rooms.

While the cleanroom environment reduces or nearly eliminates particulate contamination, pests can be brought into a production facility in material shipments. For example, bails of peat moss may introduce pests such as fungus gnats.

Because the environment in a production facility is an ideal environment for plants to grow, it is also a beneficial environment in which pests can thrive. In an embodiment, biological controls function to control pests that are inadvertently introduced from the external environment. In an embodiment, an organic soil treatment spray containing a pest nematode, a parasite that attacks fungus gnat larvae, is applied to the soil at regular intervals to control the fungus gnats.

In another embodiment, a preparation made from worm castings, typically known as “worm tea” is applied to the soil, also for controlling insect pests.

Additionally, soil that has not been planted is kept moist in order to maintain the soil ecosystem. In an embodiment, planting trays filled with soil that have not been planted are maintained on a regular watering cycle to maintain the biological activity in the soil at a healthy level. In an embodiment, the unplanted trays are maintained on a seven-day watering cycle. It will be appreciated that even an unplanted tray constitutes a miniature ecosystem that may be thought of as a living factory, promoting the action of microorganisms in the soil, whether or not the soil contains plants.

In an embodiment, the soil may be sterilized, either thermally or chemically, in order to eliminate pests. While soil sterilization is an effective pest control method, it has also been found to adversely affect the soil quality, as demonstrated by impaired plant growth. Thus, it is to be appreciated that vigorous plant growth is a by-product of a healthy soil system.

### Storage Life

The storage life of produce grown by the presently described methods has been demonstrated to be considerably longer than that of conventionally-sourced produce. Because, at the time of delivery, the produce has been harvested within 24 hours before delivery, it stays fresh under refrigeration perhaps for as long as two weeks. Because produce is grown locally, it is available to be eaten the same day as it was harvested, or soon after. Even in major urban centers, food can thus be picked, delivered and eaten, all on the same day, or soon thereafter.

By contrast, today's national supply chain for produce is all refrigerated. There are giant refrigerated warehouses across the country, and fleets of refrigerated trucks for transporting the produce. In spite of such impressive infrastructure, the produce doesn't always stay refrigerated—sometimes it is unloaded to a dock and it is not get moved inside because the truck to the next destination is only three hours away. Thus, the produce may sit in the sun for several hours. Typically, grocers and retailers report spoilage of 30-40%, because the outer leaves are bad, or because the whole plant went bad. The conventional distribution chain therefore involves large amounts of wasted inventory.

### Food Safety

The production methods described herein are extremely conducive to maintenance of food quality and food safety, providing a comprehensive audit history at a granularity approaching that of a single plant. In an embodiment, every single growing tray is tracked: the history of every plant, starting with the seed source, and every component that goes into the system—the soil and the water, for example—is known and recorded. Because the history of every tray harvested is known and readily available, if a question about contamination or any other safety/quality issues is raised, the process provides nearly perfect traceability all the way to the start of the process for every crop ever harvested. The whole history of every plant is known, so it can be determined nearly down to the individual plant what its experience has been, going through up to the point where it is delivered to the customer. By maintaining such a rigorous audit history, the possibility that a crop may be inadvertently watered with contaminated water, for example, is reduced nearly to zero.

### Monitoring

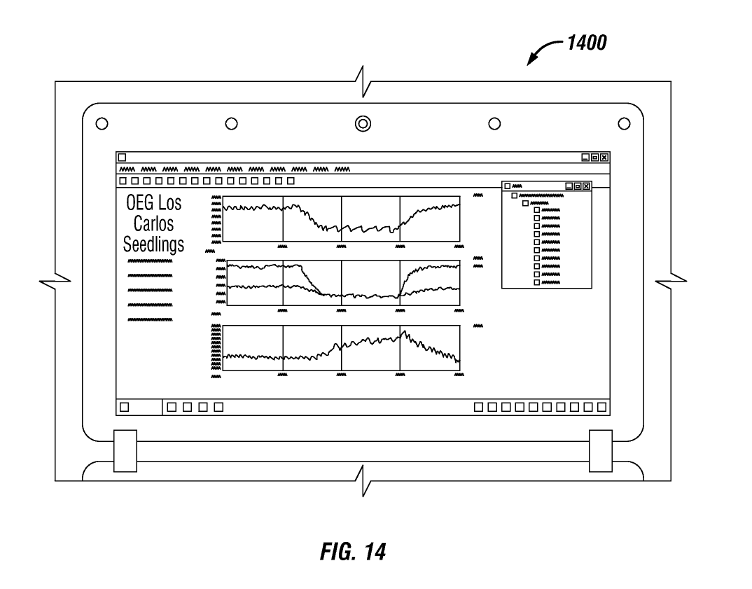

In an embodiment, wireless sensors are deployed in the grow trays themselves to measure moisture, temperature, light levels, and other environmental factors. Such measurements provide an intelligent picture of the process, essentially, a living record, of the environmental changes experienced by each plant. Measurements can be made and wirelessly reported to a computer for analysis, action taken based on the analysis and stored and/or archived. Thus, the system provides a computerized telemetry system for monitoring and reporting environmental changes experienced by the plants at a granularity no coarser than a single grow tray. FIG. 14 shows a UI (user interface) 1400 to the system from which data can be viewed. Depending on the number of inputs from each tray, the reporting granularity may even approach that of a single plant. In an alternative embodiment, the sensors are hard-wired to the data processing equipment.

It will be readily appreciated that the optimization processes described above in order to produce predictable changes in selected physical characteristics of the plants is greatly facilitated by the automated gathering of actionable environmental data, and automated modulation of the lighting parameters and watering in order to induce the changes to the physical characteristics of the crop. Furthermore, inducing such changes predictably and repeatably is greatly facilitated by the knowledge base that gradually accrues as a result of gathering and storing environmental data over time periods of varying length.

In an embodiment, timing of the lighting system is controlled by a software program wherein each of the trays is individually addressable through the program, completely automating the process of light modulation at the granularity of LED panels and eliminating the need for manually-controlled timers.

In an embodiment, dedicated watering stations are physically isolated from the remainder of the production facility in order to minimize the possibility of electrical failure. A typical watering cycle may be weekly. In an embodiment, the watering cycle may be computer-controlled in much the same way that light modulation is controlled.

As previously mentioned, the data inputs are also used to inform the audit trail for quality control and regulatory activities.

### Centralized Control of Production Facilities

In an embodiment, the system may include a number of production facilities, possibly situated at great distance from each other. In an embodiment, the multiple production facilities may be under centralized, automated control from a central operations center. Such centralized control simplifies control of such important operational aspects as workflow configuration and recipe control, thus preventing individual facilities from deviating from centrally-issued workflow configuration and recipes, ultimately to improve product consistency and quality, even across far-flung locations. Additionally, order processing can take place centrally. For example, if Gordon Ramsey wants red lettuce in all of his restaurants throughout the world, for example, then one could go into the computer at one location and say that these trays are going to be treated with certain lighting; this is Gordon's mix: his color, and he's the only one that gets this.

An additional benefit of centralized control by means of a system-wide IT network is the ability to maintain tight control of the organization's trade secrets, keeping them tightly locked down and divulging only the pieces needed at each facility, preventing an operator running an end operation from knowing an exact recipe, for example.

In addition to controlling workflow and recipes, an embodiment also controls the environmental inputs centrally, the lighting cycle, for example, also providing strong trade secret protection, but also providing opportunities for energy optimization, allowing lighting to be varied according to local conditions. For example, in an area where it gets exceptionally cold, the coldest part of the day may be the time when the lights should be kept off, thus optimizing the lighting routine to the natural thermal cycle.

### Local Conditions

As above, a system of multiple production facilities connected via a robust IT infrastructure has the opportunity of incorporating local conditions into the process. Such local conditions may include weather conditions and pricing issues. For example, a lot of places have different power rates, depending on time of day. Thus optimization for a location can be thought of as a problem of balancing ambient conditions and economic conditions. For example, a manager of a facility in Southern California may bring everything on at night when ambient conditions are cool, while locking everything down during the day, allowing him to reduce his electricity rate by a significant amount. Thus, the lighting cycle may actually be flipped.

### Solar-Generated DC

An embodiment obtains its power supply in the form of solar-generated DC (direct current). Unlike conventional solar power systems, the system runs on DC, instead of going through a step-up to an inverter and than a step-down, as in the conventional system. Because DC/AC inverters are huge energy wasters, the use of a system that eliminates the inverter provides yet another way to conserve energy and reduce cost. Additionally, inverters are commonly known to have a high failure rate, constituting a weak link in a solar generation system. Thus, the elimination of the inverter increases reliability of the system while saving the cost incurred to replace the inverter when it fails. An additional disadvantage of inverters is that they are subject to being shut down by the local utility with little or no notice, for example, when the utility needs more voltage. Another opportunity to utilize local sun patterns is to direct-drive the system with the solar-generated DC and supplement with a bank of batteries for off-peak use.

### Marketing

Decoupling the produce farming from the seasonal fluctuations and the unpredictability of the external environment creates opportunities that simply are not possible in conventional outdoor farming or in greenhouse farming.

For example, the conventional farmer is at the mercy of the seasons—when he has to grow, he grows—a classic “push” approach. The only option available to the conventional farmer is to grow all he can, and to hope that the prices will be high. Furthermore, the conventional farmer is at the mercy of the commodities market, which largely determines the price at which the farmer is able to sell a crop months before the crop is harvested and brought to market.

Unlike the conventional “push” approach, the present system and methods create the opportunity for a “pull” model of growing, wherein the producer grows to meet a demand profile in which a customer places an order, and the order is grown. Thus, the producer is able to forecast, at least two months in advance, with at least reasonable certainty, what demand is going to be, based on the orders being currently received. Thus, the producer has the flexibility to modulate his/her growth pattern to fit demand, rather than producing with the hope that the produce will sell.

It will be appreciated that certain varieties are more and less valuable at different times of the year and conventionally, certain items are not available at all during certain seasons. Because the producer is decoupled from the limitations of conventional seasonal farming, he/she also acquires the opportunity to optimize the time when selected varieties are brought to market and to optimize the price charged so that the producer is more likely to recover a reasonable profit for his/her merchandise. For example, in the winter, the producer could completely flip the selection of produce being grown, which would place the producer in competition with growers from the southern hemisphere, who ship merchandise to the north during the winter when it cannot be grown in the north. However, the present model enables production of such varieties at a lower cost because it is locally produced.

The present system and methods also allow the producer to offer a mix of varieties that complements whatever is being conventionally produced in the locale. Thus, if it happens to be peak strawberry season in the local area, strawberries would be a poor choice of crop for the producer. Instead he/she grows something else that is out of season. Or, with lettuces, during one or two periods during the year, everybody can grow lettuce, so another choice of crop would sell better at these times of year.

Additionally, the present system and methods render it feasible to profitably produce even in very small quantities. Thus, the producer can grow specialty items that are hard to find because it is unprofitable to grow them on a large scale. Additionally, it becomes feasible to produce varieties that just aren't viable on a typical farm because they are very susceptible to diseases or pests, for example.

Again, growing to demand and forecasting demand is greatly facilitated by a robust IT infrastructure, which enables the gathering and storage of large volumes of data such as sales data, demand data and inventory data from which demand can be inferred and forecasted.

Thus, the growing of crops is transformed from a seasonal affair into a year round industrial process providing much greater predictability about the outcome because it is not subject to the forces of nature: winds, hail storms, heat wave, rainstorms and so on. Nor is it subject to infrastructure failures such as power outages. In the event of a power outage, the plants readily survive at least for several days.

### Seed Propagation

An embodiment provides a production facility for seed propagation. The presently-described methods and processes assume ready availability of large amounts of quality seed. The clean, secure environment maintained in the production facility creates the opportunity to grow seeds of exceptional quality and to preserve seed stocks. As described herein above, rigorous quality control and a detailed audit trail are maintained from the very start of the process until delivery of the product to the customer. One aspect of such quality control is control of the seed supply, so that seed of a verifiable quality is always available.

The clean, positive-pressure environment provided by the production facility eliminates any possibility of cross pollination and resulting contamination of the seed stock. The use of positive air pressure enables an embodiment wherein a portion of a facility, such as a single room, can be dedicated to propagation of seed for a single variety, reducing the possibility of contamination of the seed stock from cross-pollination to near zero.

In an embodiment, the seed propagation facility can be used for propagating seed stocks of rare and unusual heirloom varieties.

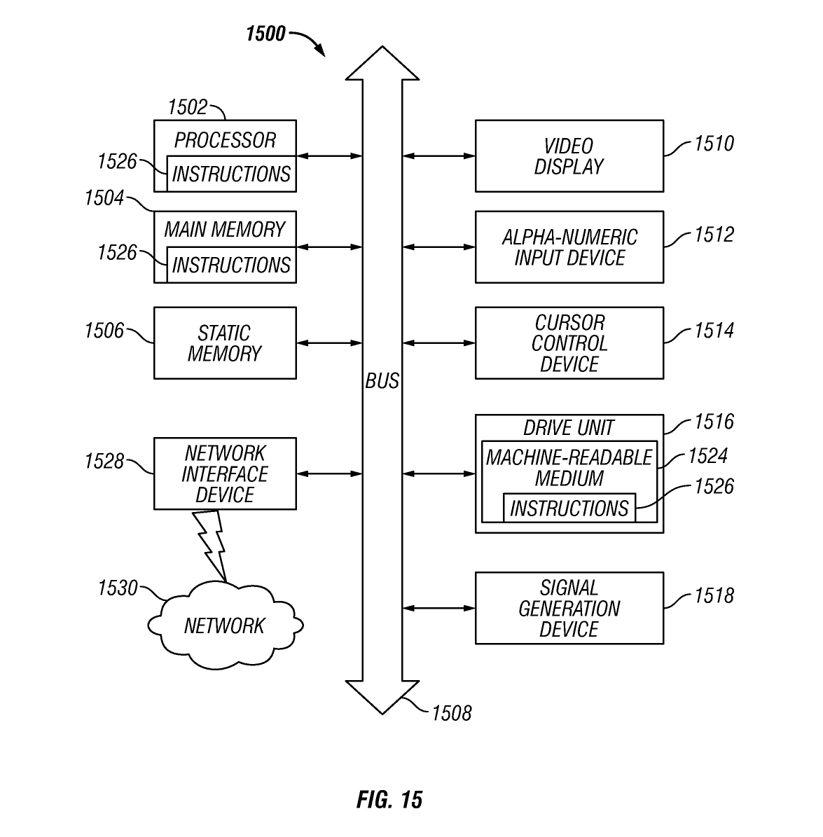

Referring now to FIG. 15, shown is a diagrammatic representation of a machine in the exemplary form of a computer system 1500 within which a set of instructions for causing the machine to perform any one of the methodologies discussed herein below may be executed. In alternative embodiments, the machine may comprise a network router, a network switch, a network bridge, personal digital assistant (PDA), a cellular telephone, a web appliance or any machine capable of executing a sequence of instructions that specify actions to be taken by that machine.

The computer system 1500 includes a processor 1502, a main memory 1504 and a static memory 1506, which communicate with each other via a bus 1508. The computer system 100 may further include a display unit 110, for example, a liquid crystal display (LCD) or a cathode ray tube (CRT). The computer system 1500 also includes an alphanumeric input device 1512, for example, a keyboard; a cursor control device 1514, for example, a mouse; a disk drive unit 1516, a signal generation device 1518, for example, a speaker, and a network interface device 1528.

The disk drive unit 1516 includes a machine-readable medium 1524 on which is stored a set of executable instructions, i.e. software, 1526 embodying any one, or all, of the methodologies described herein below. The software 1526 is also shown to reside, completely or at least partially, within the main memory 1504 and/or within the processor 1502. The software 1526 may further be transmitted or received over a network 1530 by means of a network interface device 1528.

In contrast to the system 1500 discussed above, a different embodiment of the invention uses logic circuitry instead of computer-executed instructions to implement processing offers. Depending upon the particular requirements of the application in the areas of speed, expense, tooling costs, and the like, this logic may be implemented by constructing an application-specific integrated circuit (ASIC) having thousands of tiny integrated transistors. Such an ASIC may be implemented with CMOS (complimentary metal oxide semiconductor), TTL (transistor-transistor logic), VLSI (very large scale integration), or another suitable construction. Other alternatives include a digital signal processing chip (DSP), discrete circuitry (such as resistors, capacitors, diodes, inductors, and transistors), field programmable gate array (FPGA), programmable logic array (PLA), programmable logic device (PLD), and the like.

It is to be understood that embodiments of this invention may be used as or to support software programs executed upon some form of processing core (such as the Central Processing Unit of a computer) or otherwise implemented or realized upon or within a machine or computer readable medium. A machine-readable medium includes any mechanism for storing or transmitting information in a form readable by a machine, e.g. a computer. For example, a machine readable medium includes read-only memory (ROM); random access memory (RAM); magnetic disk storage media; optical storage media; flash memory devices; electrical, optical, acoustical or other form of propagated signals, for example, carrier waves, infrared signals, digital signals, etc.; or any other type of media suitable for storing or transmitting information. Additionally, a “machine-readable medium” may be understood to mean a “non-transitory” machine-readable medium.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative sense rather than a restrictive sense.

1. A process for growing produce, the process comprising:
in a production facility equipped with at least one production lane, producing non-compartmentalized growing trays of plants growing in a soil blend engineered to have absorptive characteristics that provide a predetermined soil moisture level and a watering cycle of predetermined length, the soil blend also engineered to have nutritional characteristics that provide a plant growth cycle of predetermined length;
advancing individual growing trays of growing plants along the production lane toward a watering station on a gravity-fed growing rack;
as the growing trays advance along the production lane, illuminating the growing plants with light at frequency, intensity and duration selected to produce desired plant characteristics within a predetermined growing cycle;
as the growing trays reach watering stations along the production lane, adding water in amounts calculated to maintain the predetermined soil moisture level; and
controlling environmental inputs to maintain plant health and produce plants within the plant growth cycle of predetermined length, the plants having at least one predetermined desired characteristic.

2. The process of claim 1, wherein the production facility comprises an insulated enclosure equipped with a HVAC ((heating, ventilating and air-conditioning) system that maintains a positive air pressure within the enclosure relative to an external environment and an ambient temperature within the enclosure that is approximately equal to room temperature, the HVAC system including at least one component for shielding against particulate contamination and pest infiltration from the external environment.

3. The process of claim 1, wherein the advancing individual trays of growing plants along the production lane toward a watering station on a gravity-fed growing rack comprises iteratively performing:
at the watering station, removing a first growing tray from a queue of growing trays within the growing rack;
watering the removed growing tray; and
allowing the remaining growing trays within the queue to index downward through the force of gravity, until all the growing trays have been watered according to the predetermined watering cycle;
wherein the advancing of the individual trays of growing plants along the production lane toward a watering station on a gravity-fed growing rack further comprises any of:
replacing the watered tray in the growing rack at a rear position of the queue; and
in a sequence of production lanes, placing the watered growing tray at a rear position of a queue on a growing rack in a next production lane within the sequence of production lanes.

4. The process of claim 1, further comprising:
receiving at least one of the growing trays by a pallet for transit along the production lane.

5. The process of claim 1, wherein the illuminating the growing plants comprises:
suspending a plurality of LED panels at one or more predetermined heights by removeably placing the LED panels within a suspended grid;
combining single- and double-density panels to meet varying light requirements of different plant varieties and different light requirements of single varieties at different stages of the plant life cycle;
adjusting length of a lighting cycle by means of one or more timers; and
removing predetermined sequences of LED panels from the grid to mimic the uneven lighting encountered in natural environments.

6. The process of claim 1, wherein an LED panel comprises a plurality of LEDs of differing wavelengths selected and combined within the panel to produce light at a selected wavelength range.

7. The process of claim 1, wherein a lighting control system comprises a processing element programmed to accept input of lighting parameters and to control the lighting system according to the input parameters.

8. The process of claim 1, further comprising:
draining excess water from the growing trays to maintain the predetermined soil moisture level.

9. The process of claim 1, further comprising:
segregating a watering system and lighting systems to prevent power interruption in the event of a watering system malfunction.

10. The process of claim 1, further comprising:
raising the seedlings in a start facility.

11. The process of claim 10, wherein the start facility includes at least one multi-tiered seedling growing rack, and wherein the process further comprises:
shelving the trays of seedlings in a stacked configuration, allowing younger seedlings to be shelved at lower levels where ambient temperature is lowest; and
as the seedlings mature, moving the trays of seedling to higher levels according to the heat tolerance associated with a level of seedling maturity.

12. The process of claim 1, wherein the production facility includes a plurality of production lanes, wherein the plurality of production lanes comprises one of:
a plurality of production lanes disposed at a single level; and
at least one production lane disposed at each of a plurality of levels.

13. The process of claim 1, further comprising:
monitoring at least one environmental variable via a sensing system comprising:
at least one sensor configured for gathering data regarding at the least one environmental variable; and
an I/O (intake/output) system that accepts the gathered data regarding the at least one environmental variable as input and outputs the input data.

14. The process of claim 13, further comprising:
outputting at least a portion of the data regarding the at least one environmental variable to one or more of:
the HVAC system;
a lighting control system; and
a system for metering water.

15. The process of claim 13, wherein the at least one environmental variable comprises at least one of:
ambient temperature;
soil temperature;
relative humidity;
soil moisture;
light intensity at one or more locations;
light wavelength;
duration of light exposure;
O₂ concentration; and
CO₂ concentration.

16. The process of claim 1, further comprising:
timing illumination to coincide with a photosynthetic peak of the plants.
